(19) United States
(12) Patent Application Publication
(10) Pub. No.: US 2015/0317098 A1
(43) Pub. Date: Nov. 5, 2015

(54) ELECTRONIC APPARATUS INTERACTED WITH EXTERNAL DEVICE

(71) Applicant: Wuunet Technology Co., Ltd., Taipei (TW)

(72) Inventors: Yu-Li Kao, Taipei (TW); Wei-Yi Su, Taipei (TW); Terry Chen, Taipei (TW); You-Lin Hsieh, Taipei (TW)

(73) Assignee: Wuunet Technology Co., Ltd., Taipei (TW)

(21) Appl. No.: 14/267,895

(22) Filed: May 1, 2014

(51) Int. Cl. G06F 3/06

(52) U.S. Cl. CPC G06F 3/0659; G06F 3/0608; G06F 3/067

(57) ABSTRACT

An electronic apparatus is designed for interacting with an external device. The external device stores data like photos, document and/or data streams. The electronic apparatus includes a transmission interface, a detector and a processing circuit. The detector detects whether the external device is within a predetermined distance from the electronic apparatus, e.g. direct contact or within a distance. Besides, the external device is not wire connected with the electronic apparatus. The processing circuit automatically performs a data connection with the external device when the detector detects the external device within the predetermined distance.

### FIELD OF INVENTION

The present invention relates to an electronic apparatus and more particularly relates to an electronic apparatus interacting with an external device.

### BACKGROUND OF INVENTION

Various advanced technologies are developed and electronic devices of huge size in the past can now be made with small size and even more powerful. To satisfy different needs of home and office activities, various devices like set-top boxes and wireless routers are designed and produced. However, when there are more and more devices, it is more and more important to enhance such devices like set-top boxes and wireless routers to have more functions and more flexibility to be more convenient for users.

### SUMMARY OF INVENTION

According to a first embodiment, an electronic apparatus is provided to interact with an external device. The external device is capable of storing electronic documents like photo images, documents, data streams. The electronic apparatus includes a transmission interface, a detector and a processing circuit.

The detector is used for detecting whether the external device is within a predetermined distance. For example, the external device contacts the electronic apparatus or is located within a predetermined distance. In addition, the external device is not wire connected with the electronic apparatus.

The processing circuit automatically establishes a data connection with the external device via the transmission interface according a predetermined setting when the detector detects the external device is located within a predetermined distance. With the data connection, at least one electronic document satisfying the predetermined setting is moved to the electronic apparatus. In addition to the above function, the processing circuit may be added with various additional functions, under different designs, to produce different electronic apparatuses. For example, the processing circuit is added with functions to become a set-top box, a wire or wireless router or a network attached storage (NAS).

In some designs, the data connection includes sending a message to the external device. For example, when the external device like a mobile phone, a tablet computer like iPAD, a camera or a portable hard drive with wireless transmission capability is detected within the predetermined distance, the electronic apparatus sends a network instruction, a push message, a Bluetooth message or a NFC message to inform the external device. When the external device like a mobile phone receives such message, a predetermined operation is triggered. For example, the external device prepares files to be transfer, activates associated processing procedures, e.g. to play multimedia files, establishes a connection with a remote server, and/or communicates with other remote devices.

After the data connection is established between the electronic apparatus and the external device, electronic documents may be transmitted, but such operation is only an example and there are various operations that may be set to be activated on the electronic apparatus and the external device. For example, when the external device is put upon the electronic apparatus, it may be configured for the external device and the electronic apparatus to add, update, and/or delete file documents, to perform data backup on the external device, to perform memory management, to perform disk defragmentation, and/or to charge the external device.

The transmission interface may be designed according to various wire and/or wireless communication standards or various data transmission protocols.

The electronic apparatus may further include a storage and the processing circuit moves the electronic document as mentioned to the storage. The electronic apparatus may further include a plugging interface for a user to plug in or detach the storage. For example, the plugging interface may be a standard USB or Thunderbolt transmission interface for connecting memory cards, thumb drives or various external hard drives. According to different storages or different types of storages plugged via the plugging interface, the processing circuit determines different electronic documents from the external device.

For example, a user may prepare different external USB drives, one for work and another for family photos. In an illustrated example, the external device is a mobile phone and there are work files and family photos in the mobile phone. In this example, the electronic apparatus is plugged with an USB external hard drive for work and when the mobile phone is put near or above the electronic apparatus, the work files are automatically transmitted to the USB external hard drive directly. In another case, when the electronic apparatus is plugged with another USB external hard drive for family photo, and when the mobile phone is put near or above the electronic apparatus, the family photos are automatically transmitted to the USB external hard drive.

The electronic apparatus may provide a setting interface for a user to set the predetermined setting as mentioned above. For example, the predetermined setting may include that when the electronic document is moved to the electronic apparatus, the electronic document is removed from the external device.

Besides, the data connection may be a direct connection between the electronic apparatus and the external device, without via a third device. An alternative way of the data connection is to establish connection between the electronic apparatus and the external device via a wireless router, e.g. via a local network with a Wi-Fi AP (Access Point). Another alternative way of the data connection is to establish a point-to-point (P2P) connection between the electronic apparatus and the external device, e.g. using various hole punching technologies for establishing P2P connection. An embodiment to establish P2P connection includes assigning the electronic apparatus a first identification code and the external device a second identification code. The first identification code and the second identification code are not network addresses. One or more than one server manage the first identification code and the second identification code. The server also helps the electronic apparatus and the external device to establish the data connection in P2P approach. Specifically, the electronic apparatus and the external device retrieve connection data from the server and use such information to establish P2P connection to perform data transmission.

Besides, the predetermined setting may include determining whether the external device stays within the predetermined distance longer than a predetermined time period. If the staying time exceeds the predetermined time period, associated processing is triggered. For different design needs, the electronic apparatus may be configured to interact with different external devices. Each external device may have different identification data. The processing circuit provides data connections of different settings for external devices having different identification data.

In addition to simple file copy, the processing circuit may also be designed to process and transmit an electronic document received from the external device to a player to play. Besides, the processing circuit may be designed to transmit the received electronic document to an external storage device. Besides, the processing circuit may be designed to acquire the predetermined setting and associated processing logic corresponding to the received electronic document from the external device via the data connection. In other words, the predetermined setting may be stored and/or set on the external device like a mobile phone, e.g. to be stored in an XML file. Via the connection between the external device like the mobile phone and the electronic apparatus, the predetermined setting is transmitted to the electronic apparatus for setting the electronic apparatus.

In an embodiment, the external device is attached with an RF-ID (Raido Frequency Identification) and the RF-ID is corresponding to an identification code. The detector reads the identification code of the RF-ID to determine whether to establish the data connection and/or to transmit the electronic document.

Alternatively, in another embodiment, the electronic apparatus may be designed to trigger other processing except transmitting files as defined in predetermined setting. For example, the external device may detect the identification of the external device put upon the electronic apparatus via RF-ID, determine whether authenticated to activate associated processing, and/or trigger different processing. Alternatively, the electronic apparatus may try to establish a data connection with the external device, e.g. via a P2P connection, and then identify which external device is put upon the electronic apparatus, and then determine which is the corresponding processing to be triggered.

For example, the electronic apparatus may be disposed with a wireless charger. When the electronic apparatus detects an external device put upon the electronic apparatus, the type or identification of the external device is detected and a corresponding charging is applied to the external device according to an associated predetermined setting.

The detector may be a camera for reading a identification image of the external device to determine the identity of the external device and to determine whether the external device is within a predetermined distance. The detector may be designed as a infrared (IR) detector or other light detector. The detector may also detect relative position between the external device and the electronic apparatus. For different relative positions, the processing circuit and the electronic apparatus may activate different processing.

The electronic apparatus may also include a plugging interface for connecting to an external storage. For example, a USB interface is used for connecting an USB external hard drive.

In other words, a user may integrate an USB external hard drive of 2.5″, 3.5″ or any other size. Such design enhance mobility, space efficiency and safety. Besides, when the USB interface is used, a standard USB external hard drive can be used. This brings great convenience because such USB external drives can be easily plugged in and detached from the electronic apparatus. When the USB external hard drive is detached from the electronic apparatus and connected to a third device like a computer, files stored in the USB external hard drive can be moved to the third device. In addition, using the USB external hard drive, files in a computer can be moved into the electronic apparatus and used by the electronic apparatus.

With different design requirements, such electronic apparatus can be a set-top box connecting to a television, a wire or a wireless network attached storage (NAS), a wireless or wire router like a Wi-Fi Access Point (AP), or any other electronic devices of various applications. For example, to provide set-top box function, the electronic apparatus may include a display interface, the processing circuit provides video frames and uses the display interface to transmit the video frames to a display. For another example, to provide router function, the processing circuit may include a wireless or a wire router circuit. In addition to the USB external hard drive, the electronic apparatus may also provide storage space for disposing external memory cards, external thumb drives, and/or internal hard drive or other memory storage devices.

In one embodiment of the electronic apparatus, the hard disk storage space is formed by a cover and a surrounding wall. There are various ways to implement the cover for different needs. For example, the cover has at least a screw structure for a user to fix the cover and the surrounding wall. In another example, the cover may be rotated with respect to an pivot to open the hard drive storage space to put in or remove the USB external hard drive. In another example, the cover may be a sliding plate capable of being moved with respect to the surrounding wall to expose or close the hard drive storage space. In another example, the housing of the electronic apparatus is disposed with a drawer to form the hard drive storage space. In another example, the housing may include one or more clips for fixing the USB external hard drive to form the hard drive storage space.

With various designs mentioned above, a convenient mechanism is provided for a user to use USB external hard drive conveniently.

In addition, an electronic document management may be provided on the external device or the electronic apparatus. The external device or the electronic apparatus is provided a setting interface for a user to configure multiple network storage source. In this embodiment, a processing module is provided in the external device or the electronic apparatus as a corresponding hardware circuit and/or software application modules. For example, the processing logic of the processing module is packaged as an application program (APP), the APP invokes functions in library of an operating system for further invoking corresponding hardware circuit to achieve the task defined by the processing module. The processing module accesses multiple file documents of first type from multiple network storage sources and multiple file documents of second type from local storage of the external device or the electronic apparatus. In addition, an operating interface is provided in the external device or the electronic apparatus. The processing module integrates file documents of the first type and of the second type into the operating interface. A file display unit is rendered for multiple file documents of the first type and the second type that have the same file content. The file display unit may be a icon or a visual item describing corresponding file. In addition, the operating interface provides a user to appoint one ore more than one desired storage locations selected from the local storage of the electronic apparatus and multiple network storage sources. For one or more than one file display units that are not actually stored in desired storage location selected from the local storage of the electronic apparatus and multiple network storage sources, the external device or the electronic apparatus automatically trigger data migration to desired storage sources.

The operating interface may be rendered as tree hierarchy structure, card icon structure or any other visual types. The operating interface may provide tagging mechanism for users to classify the electronic files. The setting interface may also provide a user to establish multiple settings and each setting is corresponding to a different set of network storage sources and/or is corresponding to file documents of limited types.

### BRIEF DESCRIPTION OF DRAWINGS

FIG. 1 illustrates an electronic apparatus as an embodiment according to the present invention;

FIG. 2A illustrates using an actual example of the embodiment;

FIG. 2B illustrates another status of FIG. 2A;

FIG. 3 illustrates another design of the embodiment;

FIG. 4A illustrates a first way to transmit data between an electronic apparatus and an external device like a mobile phone;

FIG. 4B illustrates a second way to transmit data between an electronic apparatus and an external device like a mobile phone;

FIG. 4C illustrates a third way to transmit data between an electronic apparatus and an external device like a mobile phone;

FIG. 4D illustrates a fourth way to transmit data between an electronic apparatus and an external device like a mobile phone;

FIG. 5 illustrates a method for migrating data among devices with an external storage;

FIG. 6 illustrates a structure according to an embodiment of the present invention;

FIG. 7 illustrates another structure according to an embodiment of the present invention;

FIG. 8 illustrates another structure according to an embodiment of the present invention;

FIG. 9A illustrates a first use status of another embodiment according to the present invention;

FIG. 9B illustrates a second use status of FIG. 9A;

FIG. 10A illustrates another use status of another embodiment according to the present invention;

FIG. 10B illustrates a portion of elements of FIG. 10a;

FIG. 10C illustrates a second use status of another embodiment according to the present invention;

FIG. 11 illustrates a structure of another embodiment;

FIG. 12A illustrates an interaction among multiple external devices and an electronic apparatus;

FIG. 12B illustrates an interaction between an external device and an electronic apparatus;

FIG. 13 illustrates a tree management interface;

FIG. 14 illustrates a tree management interface; and

FIG. 15 illustrates a card management interface.

### DETAILED DESCRIPTION

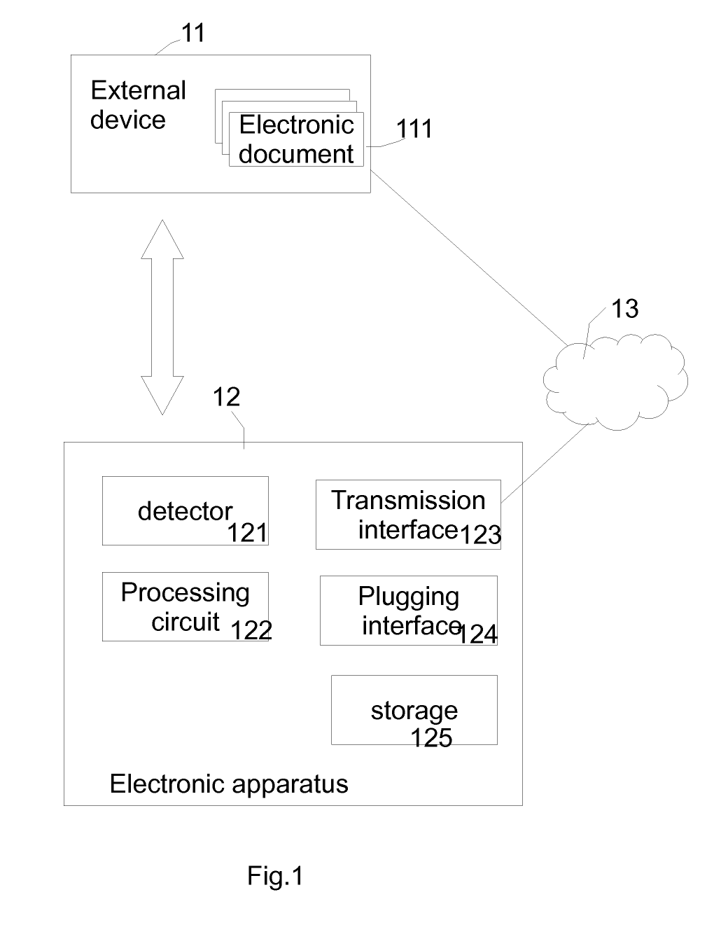

Please refer to FIG. 1, which illustrates an electronic apparatus 12 according to the present invention. The electronic apparatus 12 interacts with an external device 11. The external device 12 includes multiple electronic files 111. The electronic apparatus 12 includes a transmission interface 123, a detector 121 and a processing circuit 122. In addition, according to different design needs, the electronic apparatus 12 may further include a plugging interface 124 and a corresponding storage 125.

The detector 121 detects whether the external device 11 is within a predetermined distance with respect to the electronic apparatus 12. Specifically, the detector 121 may detect whether there is a direct contact or the external device 11 is located within a predetermined distance. In addition, in this embodiment, the external device 11 is not wire connected with the electronic apparatus 12. It is different from using a wire transmission to exchange data.

When the detector 121 detects that the external device 11 is within a predetermined distance, the processing circuit follows a predetermined setting for automatically establishing a data connection to the external device 11 via the transmission interface 123. With the data connection, one or more than one of the electronic documents satisfying the predetermined setting are moved from the external device 11 to the electronic apparatus 12.

In addition to the above mentioned function, under different design needs, the processing circuit 122 may be added with various processing capabilities to become different electronic devices like a set-top box, a wire or a wireless router, a network attached storage (NAS) or any desired devices.

The transmission interface 123 may be designed according to various wire or wireless transmission standards, or any other data transmission protocols, like NFC, Bluetooth, etc.

The electronic apparatus 12 may further include a storage 125. The processing circuit 122 moves at least one electronic document to the storage 125. The electronic apparatus 12 may further include a plugging interface 124 for a user to plug in or detach the storage 125. For example, the plugging interface is a standard USB transmission interface for connecting a memory card, a thumb drive and/or various external hard drives. The processing circuit 122 may automatically move electronic documents satisfying different conditions from the external device 11 according to different storages plugged in the plugging interface 124.

For example, a user may prepare different USB external hard drives, one for work and another for family photos. When the external device 12 is a mobile phone 12, there are work files and family photos. When the electronic apparatus 12 is inserted an USB external hard drive for work and the mobile phone is near or put upon the electronic apparatus 12, the work files are automatically transmitted to the USB external hard drive in the electronic apparatus 12. When the electronic apparatus 12 is inserted an USB external hard drive for family photos and the mobile phone is near or put upon the electronic apparatus 12, the family photos are transmitted directly to the USB external hard drive for family photos.

The electronic apparatus 12 may provide a setting interface for a user to set the predetermined setting. For example, the predetermined setting may include a rule for removing a file from the external device 11 when the file is moved from to the electronic apparatus 122. In addition, the predetermined setting may include a rule for migrating electronic files on the electronic apparatus 12 to the external device 11. For example, music files stored in an USB external hard drive in the electronic apparatus 12 may be automatically updated to the external device 11 like a mobile phone when the external device like the mobile phone is put upon the electronic apparatus 12.

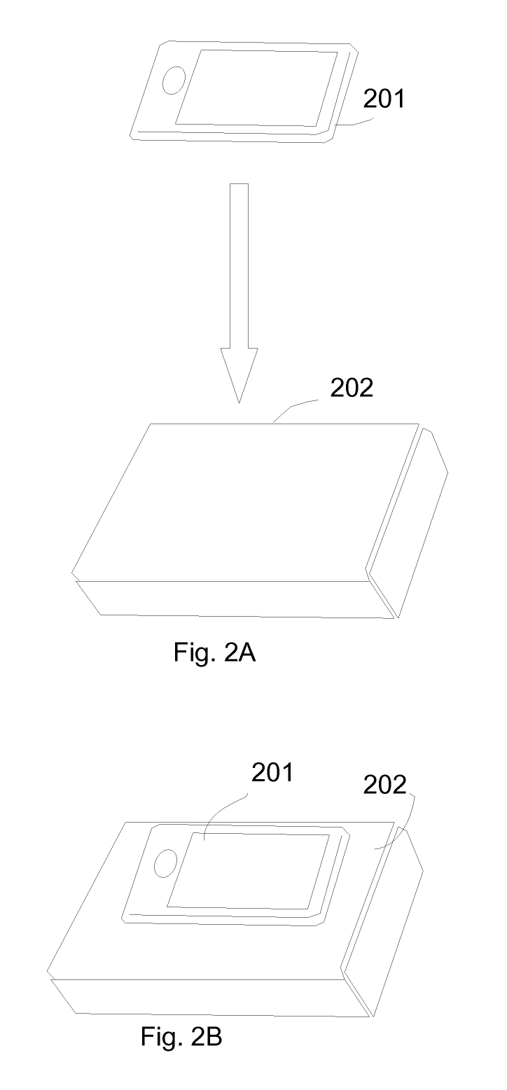

FIG. 2A and FIG. 2B illustrates a design example according to the embodiment illustrated in FIG. 1. The mobile phone 201 as the external device may be put upon a set-top box, a wireless router, and/or a network attached storage (NAS) as the above-mentioned electronic apparatus. When an authentication of a user is provided to an authentication interface on the mobile phone, data transmission is started between the external device and the electronic apparatus. Alternatively, when the mobile phone 201 is put on the electronic apparatus 202 or is located within a predetermined distance from the electronic apparatus 202, without input of the user, the mobile phone 201 may automatically start data transmission with the electronic apparatus 201. Please be noted that the mobile phone 201 may be replaced with any other electronic devices like an iPAD, a tablet computer, an/or a network storage devices.

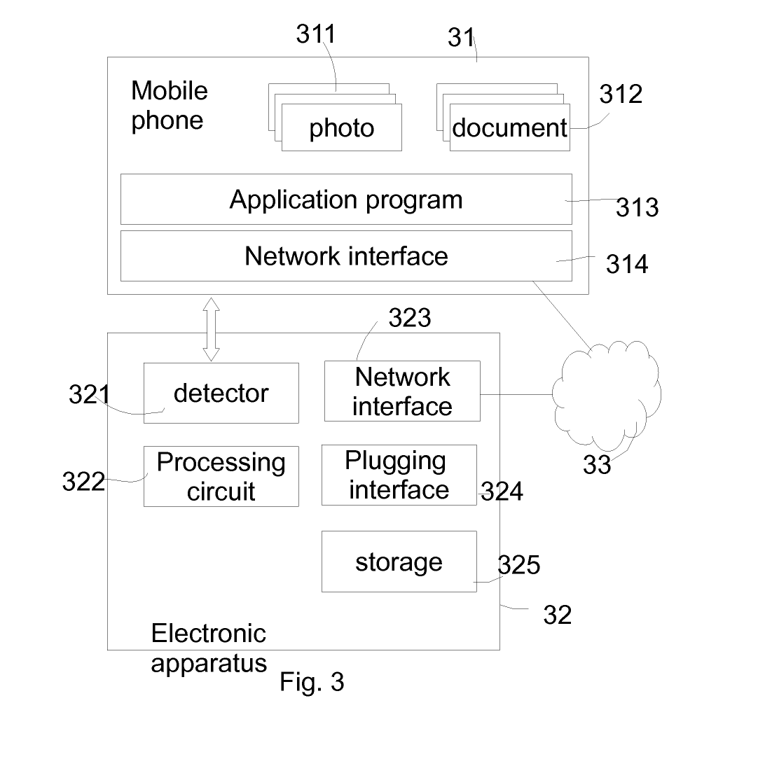

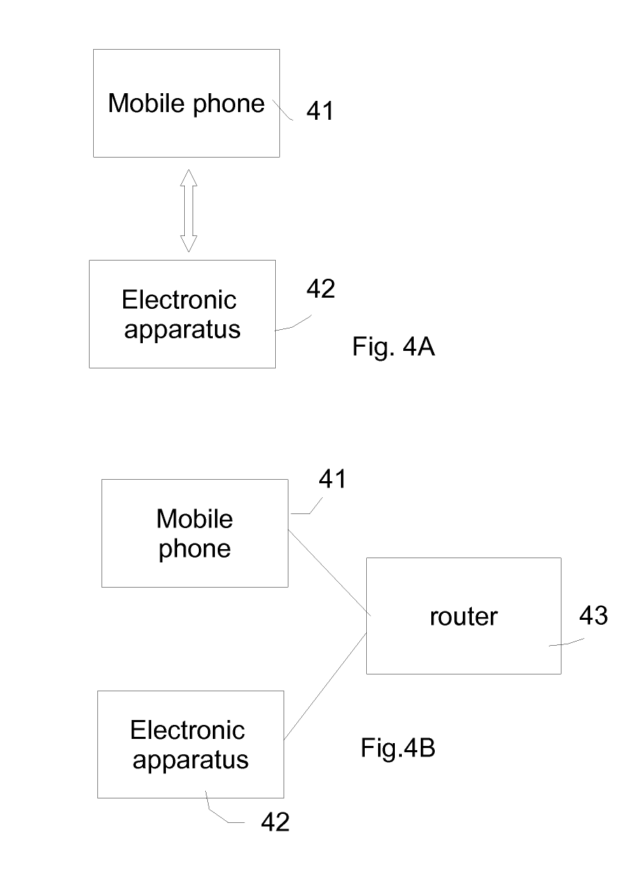

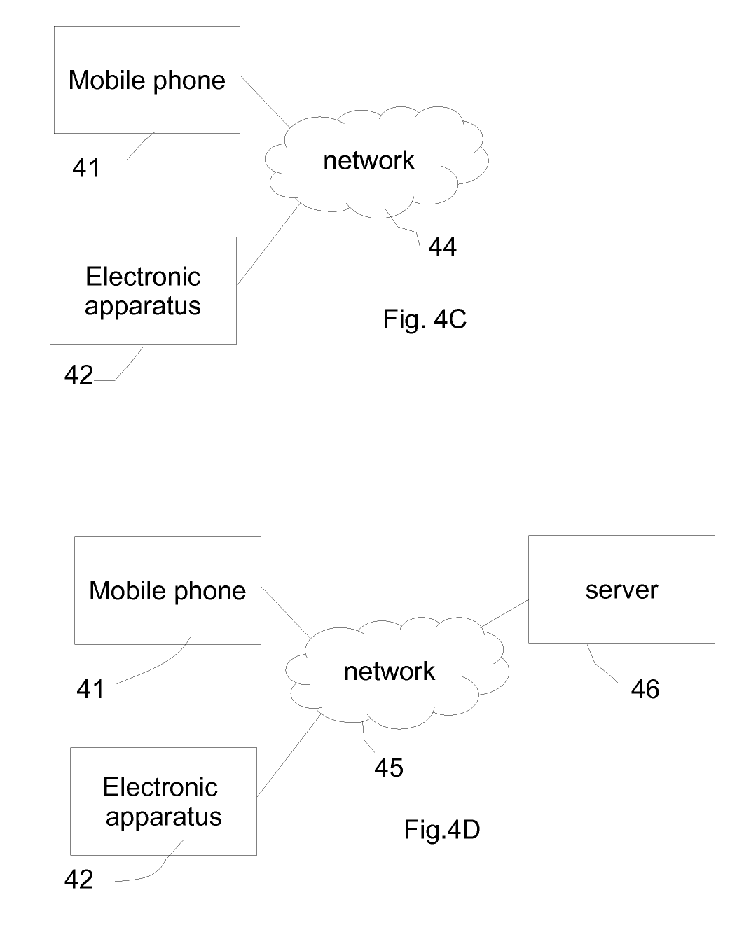

FIG. 3 illustrates a detailed implementation of FIG. 2. The mobile phone 31 has a network interface 314, an application program 313 and stores photos 311 and other file documents 312. The network interface 314 may be a combination of an operating system, driver programs and/or associated hardware circuits. The application program 313 provides operating logic defining how the photos 311 and other file documents to be processed by the electronic apparatus 32 and the mobile phone 31.

The electronic apparatus 32 includes a detector 321, a processing circuit 322, a network interface 3232, a plugging interface 324 and a storage 325. The detector 321 includes detectors of Infrared sensing or other mechanisms for detecting whether the mobile phone contacts or is located near the electronic apparatus 32. When the mobile phone 31 is found near the electronic apparatus 32, the processing circuit 322 interacts with the mobile phone 31 via the network interface 323 and the network 33. The plugging interface may be a USB interface for connecting an USB external hard drive, a memory card, a thumb drive and/or other storage 325.

As mentioned above, a user may prepare different USB external hard drives, one for work and another for family photos. When the electronic apparatus 32 is inserted with an USB external hard drive 325 for work and the mobile phone 31 is near or put upon the electronic apparatus 32, the work files are transmitted directly to the USB external hard drive in the electronic apparatus 32. When the electronic apparatus 32 is inserted with an USB external hard drive for family photos and the mobile phone 31 is near or put upon the electronic apparatus 32, the family photos are transmitted directly to the USB external hard drive for storing family photos.

There are various ways for establish the data connection between the external device and the electronic apparatus. Several embodiments of the data transmission are explained as follows with corresponding figures.

The data connection is a direct connection between the electronic apparatus 42 and the mobile phone 41 as the external device, without via a third device. For example, the electronic apparatus 42 communicates with the mobile phone 41 via NFC or Bluetooth to establish the data connection.

An alternative way to establish the data connection between the electronic apparatus 42 and the mobile phone 41 is using a local area network established by a wire or wireless local network router 43. For example, a Wi-Fi access point (AP) may create a local area network, upon which the data connection is established.

Another alternative way to establish the data connection between the electronic apparatus 42 and the mobile phone 41 is via a network 44. For example, in the Internet, if the mobile phone 41 and the electronic apparatus 42 have unique IP addresses, the mobile phone 41 may establish a TCP/UDP connection with the electronic apparatus 44 to start data transmission.

An alternative way for establishing the data connection between the electronic apparatus 42 and the mobile phone 41 is via a point-to-point (P2P) transmission. To achieve the point-to-point transmission, the electronic apparatus 42 is assigned a first identification code and the mobile phone 41 is assigned a second identification code. The first identification code and the second identification code are used for establishing the P2P connection. Specifically, a server 46 is used for providing connection data of the electronic apparatus 42 and the mobile phone 41 via the network 45 for establishing the P2P connection to start data transmission.

Besides, the predetermined setting may include a condition to determine whether the external device stayed more than the predetermined time period to prevent incorrectly trigger undesired data transmission. The electronic apparatus may interact with different external devices. Each external device may have different identification data. The processing circuit may provide different data transmission under different predetermined settings for external devices of different identification data. For example when an electronic apparatus detects a specific mobile phone or a camera put upon the electronic apparatus, the predetermined setting may include the rule of moving photo files in specific folders of the mobile phone or the camera and then removing photo files that are downloaded. For the same electronic apparatus, when a specific tablet computer or a MP3 player is put on the electronic apparatus, the predetermined setting may include transmitting the music files stored in the electronic apparatus to the tablet computer or the MP3 player.

In addition to simple file copy, the processing circuit may also process and transmit a downloaded electronic document from the external device to be played on a display device. For example, a movie file may be played on a television or a music file to be played with a speaker. Besides, the processing circuit may transmit the downloaded electronic document to one or more than one external storage device. Besides, the processing circuit may establish a data connection with the external device to retrieve the predetermined setting and associated method for processing the electronic documents. In other words, the predetermined setting may be defined in a XML file or other way and stored in the mobile phone or other external devices and then be transmitted to the electronic apparatus to configure how the electronic apparatus to interact with the external devices.

The external device is attached a radio frequency identification (RF-ID) tag corresponding to an identification code. The detector reads the identification code of the RF-ID tag to determine whether to establish the data connection and/or transmit corresponding electronic documents.

There are various ways to design the detector. For example, the detector may include a camera for reading a identification image like a QR code to determine identity of the external device and to determine whether the external device is within a predetermined distance. The sensor may detect relative positions of the external device and the electronic apparatus. For different relative positions, the processing circuit may have different interaction with the external device.

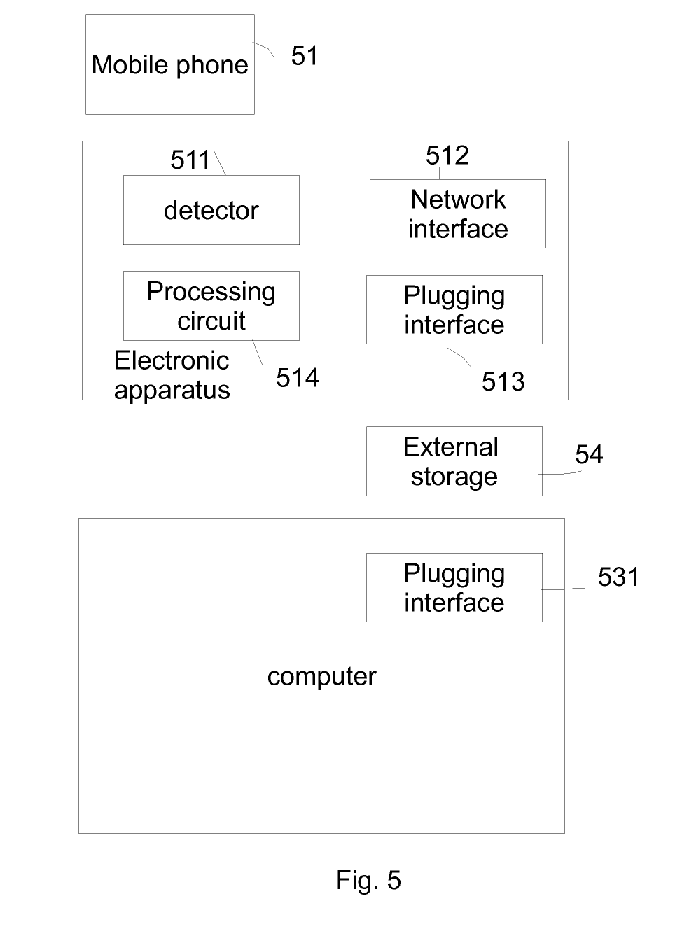

The electronic apparatus may include a plugging interface for connecting an external storage. For example, an USB interface may be provided to connect an USB external hard drive. FIG. 5 illustrates that the mobile phone 51 may interact with the electronic apparatus 52 to perform automatic or semi-automatic data transmission as mentioned above. The detector 511 detects the mobile phone 51 is near, and then the processing circuit 514 downloads corresponding electronic documents via the network interface 512. The downloaded electronic documents are stored in the external storage 54 via the plugging interface.

After the external storage 54 is stored with the electronic documents, the external storage 54 may be detached and plugged to a computer 53 via the plugging interface 531. In other words, with such use, a user may integrate an USB external hard drive of 2.5″, 3.5″ or other size with the electronic apparatus to enhance mobility, space efficiency and data safety. In addition, when the plugging interface is a USB interface, various USB hard drives may be easily inserted into and detached from the electronic apparatus. When the USB external hard drive is detached from the electronic apparatus and connected to other devices like a computer, the files stored therein may be moved to these devices. Besides, the USB external hard drive is helpful for moving files from these devices to the electronic apparatuses to be used by the electronic apparatus or the external devices as mentioned above.

The term “USB” mentioned here refers to Universal Serial Bus, including USB 2.0, USB 3.0 or other USB standards. Thunderbolt or other similar standards provide capability of connecting a hard drive and has similar way, function and result with USB standards. Therefore, these standards should be interpreted falling within the scope of present invention via Doctrine of Equivalents.

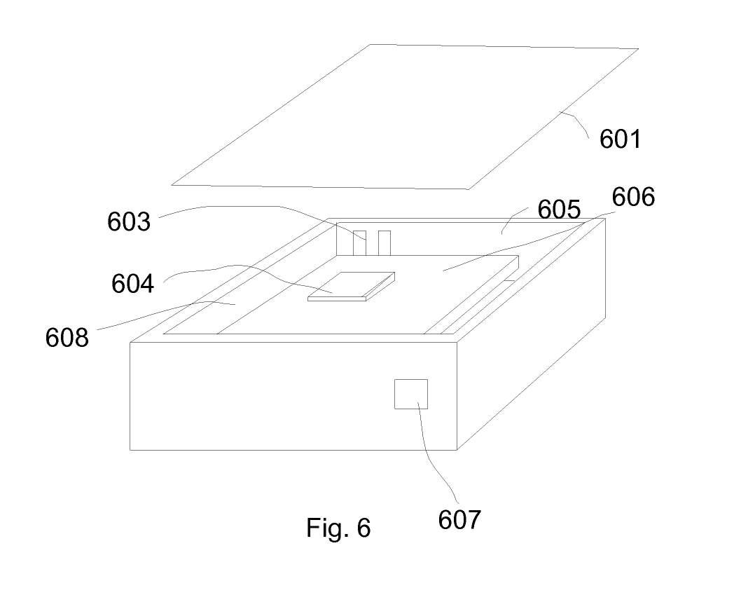

Please refer to FIG. 6, which illustrates an embodiment according to the present invention. The electronic apparatus may be a set-top box, a network attached storage (NAS), a Wi-Fi access point (AP), or any other network storage devices. The electronic apparatus includes USB interface 603, a network interface 607, a processing circuit 604 and a housing. In this electronic apparatus, the USB interface 603 is used for connecting an USB external hard drive. The network interface is used for connecting to a wire or wireless network. The processing circuit 604 is used for processing the data transmitted from the network interface 607. In addition, the housing includes a hard drive storage space 606 and the circuit storage space 608. The hard drive storage space 606 is used for storing an USB external hard drive in a predetermined position when the USB external hard drive is connected. The circuit storage space 608 is used for storing the processing circuit 604.

The network interface 607, for example may be used for connecting a cable network of a television network, may be used for connecting to an ADSL router, and may be a network card of a wireless network for connecting to an external wireless network. As mentioned above, the processing circuit 604 may be composed of different software, hardware and/or accompanied with operation systems like Android or other associated software for providing various application functions under different design needs.

In other words, a user may use an USB external hard drive of 2.5″, 3.5″ or any other size to integrate with a housing of an electronic apparatus for enhancing mobility, space efficiency and data safety. In addition, the USB interface may be plugged with a general magnetic disk drive, a SSD drive or hybrid drive with flash memories and magnetic disk drive. Such USB external hard drives may be easily moved out or inserted into the electronic apparatus. When such USB external hard drives are removed from the electronic apparatus and attached to another device like a computer, the files in the USB external hard drive may be further transmit to the attached device. In addition, the USB external hard drive may also be used for carrying files from such devices like a computer to the electronic apparatus to be used by the electronic apparatus or the corresponding external devices.

With different designs of the processing circuit, the electronic apparatus may become a set-top box, a wire or wireless network attached storage, a wireless or wire router like a Wi-Fi access point (AP). For example, the electronic apparatus may include a display interface. The processing circuit provides image frames for a display to display via the display interface. Alternatively, the processing circuit may include a wire or wireless router circuit.

In addition to the USB external hard drives, the electronic apparatus may also be disposed with storage space for storing external memory cards, external thumb drives, internal hard drives and/or other memory storage devices.

In an embodiment of the electronic apparatus mentioned above, the hard drive storage space is defined by the cover 601 and the surrounding wall 605. There are various alternative ways to implement the cover 601 for different needs. Several examples are explained as follows with associated drawings.

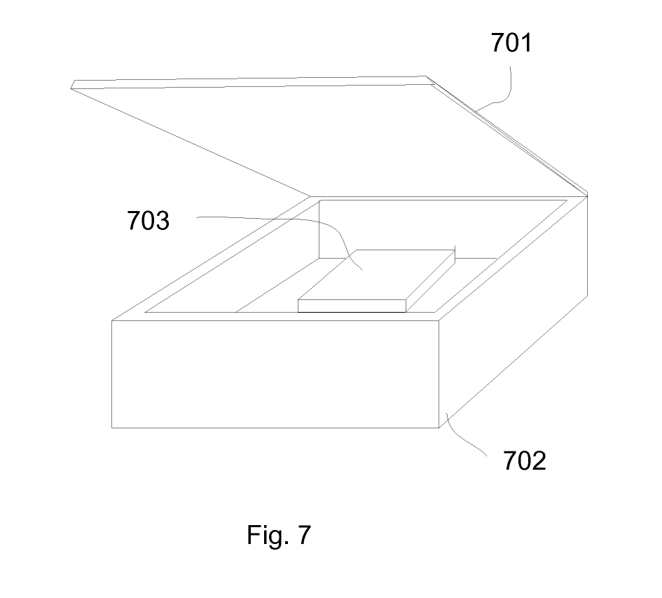

Please refer to FIG. 7, which illustrates an embodiment of an electronic apparatus according to the present invention. In FIG. 7, the electronic apparatus has a housing that has a surrounding wall 702, which is combined with a cover 701 to form a hard drive storage space in the electronic apparatus. An USB external hard drive 703 may be inserted to the hard drive storage space and the cover 701 is closed so as to integrate the USB external hard drive with a set-top box, a Wi-Fi router or other electronic apparatus to enhance mobility and data safety.

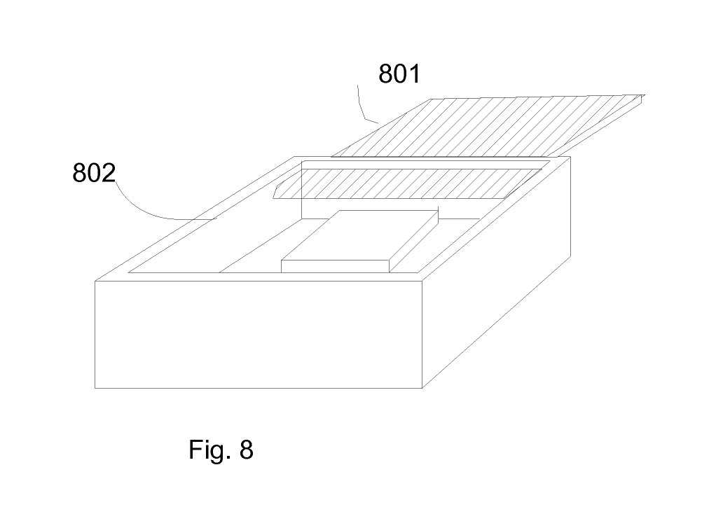

Please refer to FIG. 8. The cover 801 is designed as a slide plate that can be moved with respect to the surrounding wall 802 of the housing to open or close the hard drive storage space.

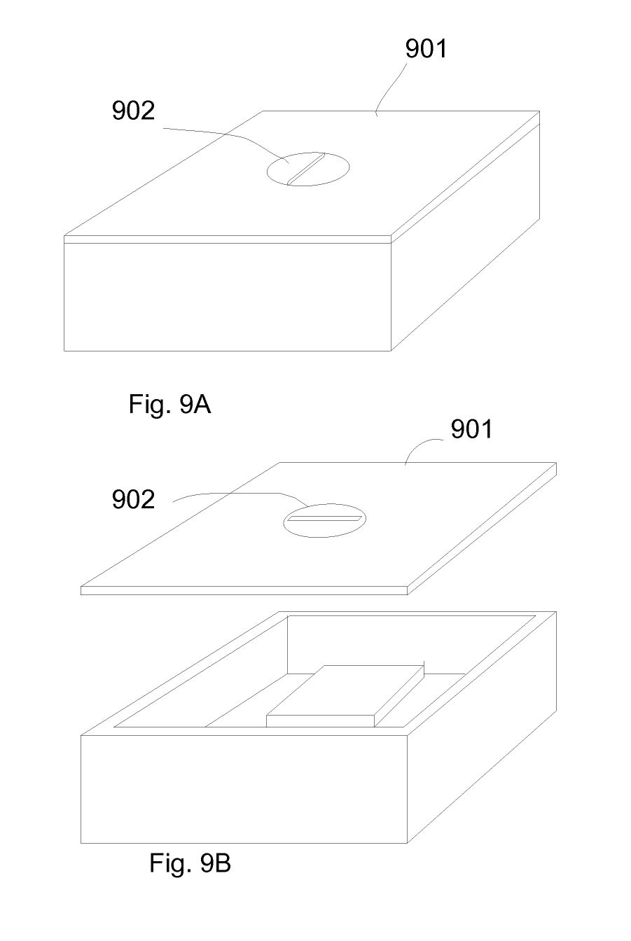

Please refer to FIG. 9A and FIG. 9B. FIG. 9A and FIG. 9B respectively illustrates open and closed statuses of the hard drive storage space. The cover 901 may be disposed with a screw structure 902 that is easily rotated, e.g. with a groove to be operated with a coin, to trigger corresponding mechanism to open or close hard drive storage space.

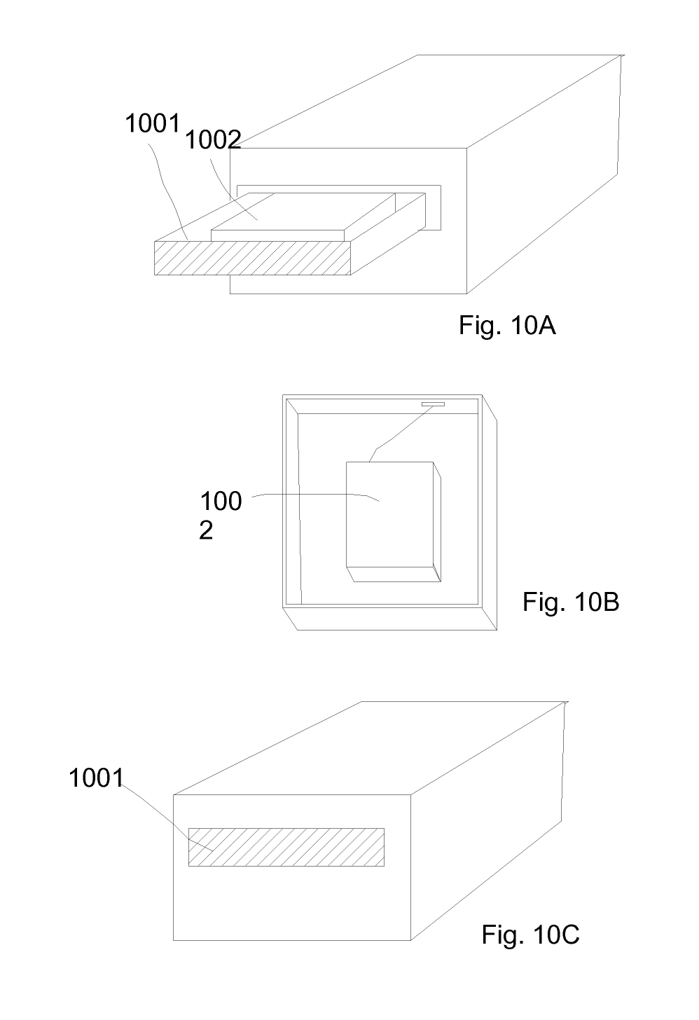

Please refer to FIG. 10A, 10B and 10C, which illustrate hard drive storage space achieved by a drawer. The drawer 1001 is used for holding an USB external hard drive 1002. When the drawer 1001 is closed, the USB external hard drive 1002 can be stored and arranged in the electronic apparatus to enhance data safety and use convenience.

In addition, clips may be disposed on a housing for fixing an USB external hard drive to form hard drive storage space.

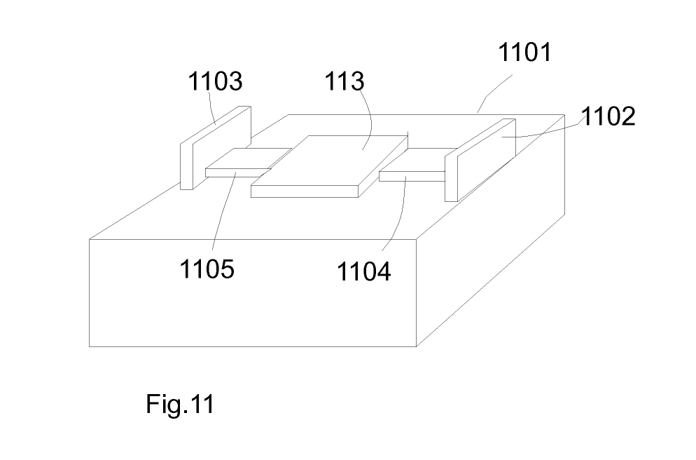

For example, FIG. 11 illustrates an embodiment using clips. In such design, the USB external hard drive is not disposed within the housing 1101 of the electronic apparatus, but fixed by the clip 1102, 1103 and associated elastic components 1104, 115. In such design, although the USB external hard drive is not placed inside the housing 1101, it can still be integrated with the electronic apparatus in a certain level to enhance use convenience and data safety. Please be noted that the pair of clips 1102, 1103 are used as example, and in real design, various types of clip structures may be used if they can help fix the USB external hard drive.

With different designs of the processing circuit, such electronic apparatus may become a set-top box connecting to a television, a wire or wireless network attached storage (NAS), a wire or wireless router like a Wi-Fi access point (AP), etc. For example, The electronic apparatus includes a display interface, the processing circuit provides video frames transmitting to a display via the display interface. The processing circuit may also include a wire or wireless router circuit.

In addition to the USB external hard drive, the electronic apparatus may also have a storage for storing external memory cards, external thumb drives, internal hard drives or other memory storage devices.

The electronic apparatus may have interactions with the external device for different relative positions between the external device and the electronic apparatus. For example, the electronic apparatus may be set for trigger different processing when the external device is detected located at front side, back side or lateral side. Alternatively, the electronic apparatus may rely on one or more than one detectors of the external device to detect the status of the external device or relative relation with the electronic apparatus. The detected result of the external device may be transmitted to the electronic apparatus. According to the detected result, either accompanied with detected result of the electronic apparatus or not, the electronic apparatus and/or the external device determines whether to trigger a corresponding processing or selected one corresponding processing accordingly. In addition to using various optical sensors, motion sensors, GPS and other detectors to collect the detected result, user schedule, time or any parameters related to enhance use of the external device may be combined or individually used. Alternatively, the electronic apparatus does not use any of its detector but rely on the detected result of the external device. For example, when the external device detects exists of the electronic apparatus, e.g. within a predetermined distance, the external device executers a data connection with the electronic apparatus and then transmit files and/or trigger any predetermined processing procedure.

In addition, more than one external devices 1201, 1202 may be integrated with the electronic apparatus 1203 to perform various data transmission according to various predetermined settings. For example, the electronic apparatus may be a relay for helping the external devices 1201 and 1202 to exchange electronic documents.

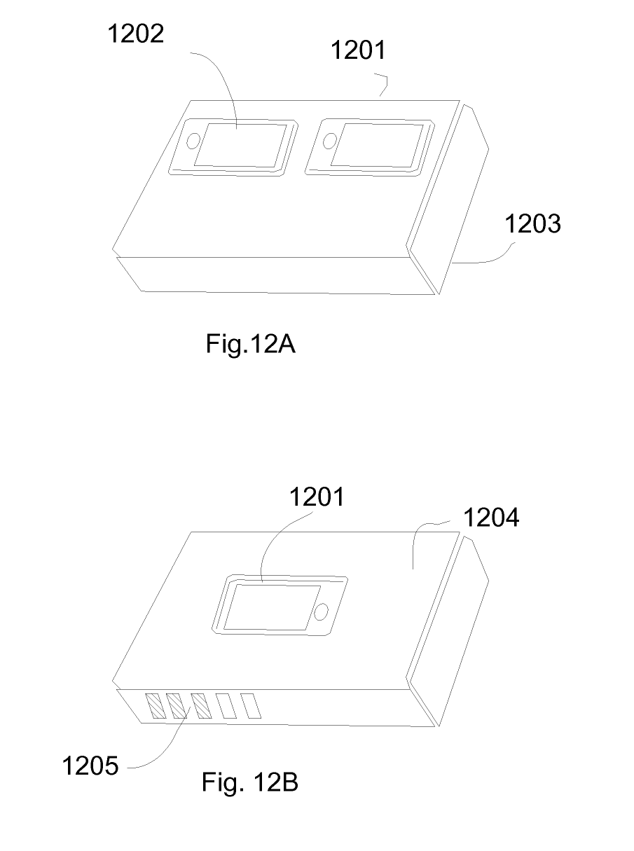

Please refer to FIG. 12B, which illustrates that when the external device 1201 and the electronic apparatus 1204 perform data transmission, the electronic apparatus is disposed with a light or a display so that a user may read the processing status of the data transmission and/or the free space of the storage in the electronic apparatus.

Besides, a wireless charger may be disposed in the electronic apparatus. When the external device is put on the electronic apparatus, the external device is charged with the electronic apparatus. During charging, it can be designed so that there are different data transmission styles according to charging status and/or other status of the external device. For example, when the battery is low in the external device, which usually indicates a longer charging time, photos with complete resolution may be transmitted to the electronic apparatus. In contrast, if there is sufficient battery of the external device, which may mean there is less time for the user to stay the external device on the electronic apparatus, photos of a mini size may be transmitted to the electronic apparatus first and when there is sufficient time, photos with complete size are transmit to the electronic apparatus.

In other words, different interactions between the electronic apparatus and the external device may be configured according to the battery status of the external device. Besides, the electronic apparatus may record and calculate history using profile to dynamically adjust how the electronic apparatus interacts with the external device.

In addition, an electronic document management interface may be provided on the external device and/or the electronic apparatus mentioned above. A setting interface may be provided on the external device or the electronic apparatus for a user to set multiple network storage sources. A processing module, like corresponding hardware circuits or software application modules, is disposed on the external device or the electronic apparatus. The processing module accesses multiple file documents of a first type from the network storage sources and/or multiple file documents of a second type from local storages of the external device or the electronic apparatus. An operating interface is provided in the external device or the electronic apparatus. The processing module integrates the file documents of the first type and of the second type in the same operating interface. For file documents with the same content in the file documents of the first type and the file documents of the second type, a single file display unit is presented. The operation interface also provides a user to set one or more than desired locations from the multiple network storage sources and/or the local storages for storing each file display unit. For file documents not actually stored in the desired location, the external device and/or the electronic apparatus chooses a source to duplicate the file document and deliver the file document to one or more than one desired locations automatically.

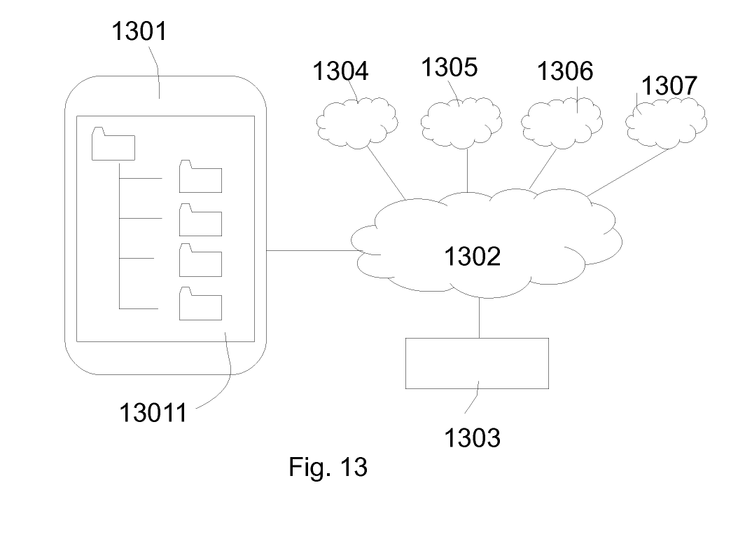

FIG. 13 illustrates a method for performing an electronic file management method on an electronic apparatus like a mobile phone 1301. The mobile phone 1301 is installed a corresponding application program (App). According to the logic defined in the App, the mobile phone 1301 shows an operating interface on its display and provides a setting interface (not shown) for a user to set multiple network storage sources 1304, 1305, 1306, 1307, e.g. Google Drive, Dropbox cloud storages or private network storage sources like a user-owned network storage 1303. Via a public network, a private network or a combination network 1302, the mobile phone 1301 accesses the file documents on these network storage sources and integrates these file documents to the operating interface 13011 of the mobile phone 1301. In the operating interface 13011, each item is a file display unit. Corresponding physical files may be stored in the local storage of the mobile phone 1301, and/or be stored in one or more than one network storage sources. A tree hierarchical structure is used for displaying these file display units in the operating interface. Each file display unit may refer to a directory with more directories and files or refer to a file.

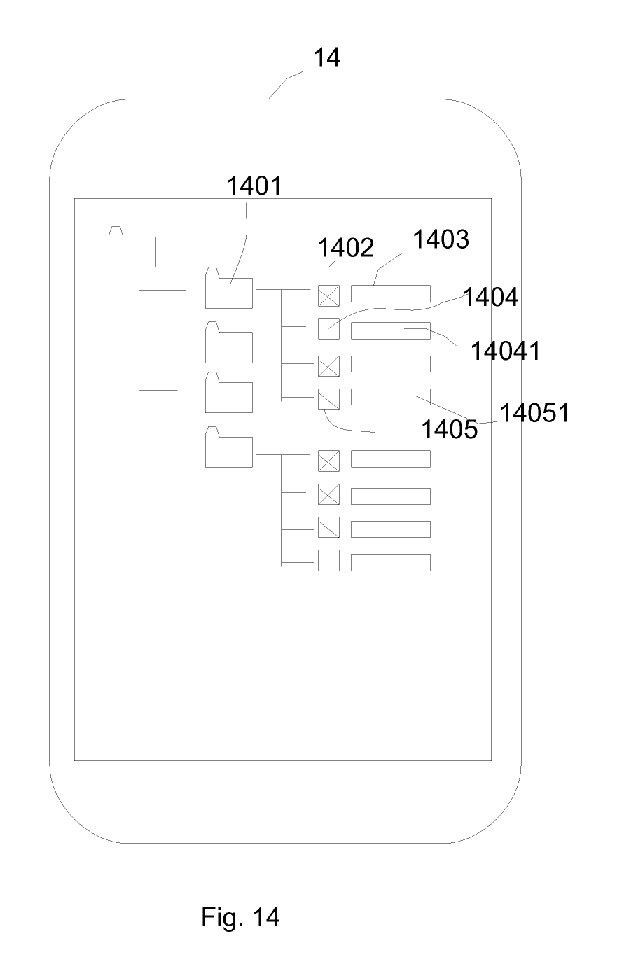

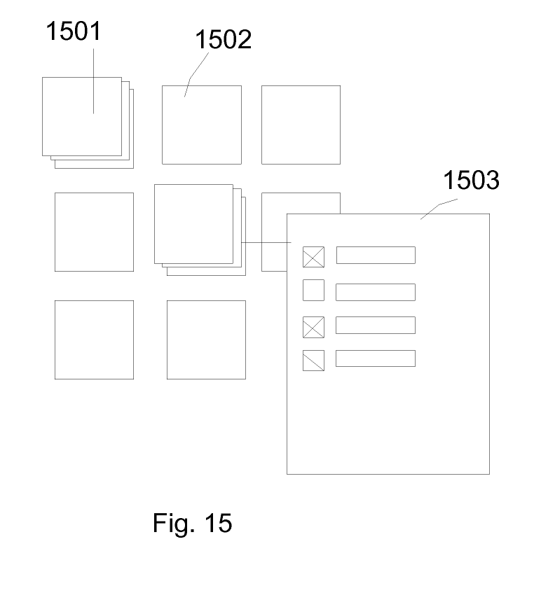

FIG. 14 illustrates that for each file display unit, the operating interface further provides an interface for a user to set one or more than one desired locations for storing physical files corresponding to each file display unit from one or more than one network storage sources. In this example, each file display unit may be selected by a user, e.g. via a touch gesture, to display a sub-operating interface to display for how many physical copies corresponding to a specific file display unit exist in one or more network storage sources. For example, the mark 1402 shows that there is a copy stored in the network storage source 1403. The mark 1404 shows that there is no copy of the file display unit 1401 in the network storage source 14041. The mark 1405 shows that a copy of the file display unit 1401 is moving to the network storage source 14051 but such moving is not complete.

A user may change these marks 1402, 1403, 1405 for instructing to remove a copy, or to add a copy to the associated network storage sources. After the user issues the instructions, the mobile phone 14 may activate data movement and processing in the background.

In addition to tree hierarchy, the electronic file management may also be designed in a card icons or any other visual forms. The operating interface may provide tagging functions to classify and arrange the file display units. For example, multiple file display units 1501 and a file display unit 1502 may be presented with card icons and a sub-operating interface 1503 may be instructed with desired locations for files to be moved, removed or copied. In addition to tagging, various alternative methods like using file extension name may be used. Multiple methods may be mixed to provide a hybrid interface. For example, several tree structure may be provided for representing different view points to organize electronic files. Copies of these electronic documents may be stored in different storage locations. For example, one file may have copies in cloud storages like Google Drive and Dropbox and private cloud storage like a NAS, a computer, a television, a tablet computer and/or local storages of the electronic apparatus.

In other words, a user may use an operating interface on an electronic apparatus to manipulate all files in different storage locations and to instruct where files are to be located. The electronic apparatus and these storages locations may exchange data via various wire or wireless networks. For example, file may be transmitted via a normal wire or wireless local network, the Internet, and/or P2P connection. When a user issues an operation instruction via the operating interface to determine whether there is a desired copy on a specific storage location or whether to remove a copy at a specific storage location, the circuit and/or software instructions of the electronic device mounting the operating interface may start performing corresponding processing. Alternatively, the operating interface may issue instructions to one or more than one electronic apparatus or servers for helping data transmission. Files may be moved directly from one storage location to anther storage location. Files can also be relayed via one ore more than one relay electronic devices or servers.

In addition, when data is moved among devices, data may be dynamically compressed or encrypted. In other words, a user may use any one of his devices to manage file documents on his one or more than one devices. For example, a user may install an App on his mobile phone and sets corresponding processing logic as mentioned above to display the operating interface so as to integrate music files on his iPad, recorded television programs on his television, EXCEL files on his Google Drive, Word files on his Dropbox server, files on his NAS, recorded videos on his IP camera, and files in specific folder on his laptop computer on the same operating interface. The user just needs to select from the operating interface to manage these files, to play these files, to add, update or remove these files, and/or change storage locations of these files. Alternatively, common operations may be coded by the user or a third party to create an operating instruction, program or a circuit so that when a user sets account information and password, corresponding operations may be executed automatically, periodically or manually.

The setting interface is provided for a user to set multiple settings, each setting corresponding to a set of network storage sources and/or corresponding to specific types of file documents.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. An electronic apparatus for interacting with an external device for storing a plurality of electronic documents, the electronic apparatus comprising:
a transmission interface;
a detector for detecting whether the external device is within a predetermined distance from the electronic apparatus, wherein the external device is not wire connected with the electronic apparatus; and
a processing circuit, when the external device being detected within the predetermined distance by the detector, for automatically establishing a data connection with the external device under a predetermined setting and for moving at least one electronic document from the external device to the electronic apparatus under the predetermined setting.

2. The electronic apparatus of claim 1, wherein the transmission interface is a network interface.

3. The electronic apparatus of claim 1, further comprising a storage and the processing circuit moves the at least one electronic document to the storage.

4. The electronic apparatus of claim 3, further comprising a plugging interface for a user to plug in and detach the storage.

5. The electronic apparatus of claim 4, wherein the processing circuit determines different electronic documents according to different storage plugged to be automatically moved from the external storage.

6. The electronic apparatus of claim 4, wherein the plugging interface is a USB interface and the storage is a USB external drive.

7. The electronic apparatus of claim 1, wherein the at least one electronic document is removed from the external device after the processing circuit moves the at least one electronic document to the electronic apparatus.

8. The electronic apparatus of claim 1, wherein the data connection is a direction connection between the electronic apparatus and the external device without via a third device.

9. The electronic apparatus of claim 1, wherein the data connection between the electronic apparatus and the external device is via a wireless router.

10. The electronic apparatus of claim 1, wherein the data connection between the electronic apparatus and the external device is via a point-to-point transmission.

11. The electronic apparatus of claim 10, wherein the electronic apparatus has a first identification code, the external device has a second identification code, and the electronic apparatus and the external device establish the point-to-point transmission with help of a server according to the first identification code and the second identification code.

12. The electronic apparatus of claim 1, wherein the electronic apparatus informs the external device to trigger a predetermined operation procedure on the external device.

13. The electronic apparatus of claim 1, wherein each external device having different identification data and the processing circuit provides different data movement according to different predetermined settings for the external devices having different identification data.

14. The electronic apparatus of claim 1, wherein the processing circuit processes and transmits the at least one electronic document received from the external device to a player to be played.

15. The electronic apparatus of claim 1, wherein the processing circuit provides a setting interface for the user to set the predetermined setting.

16. The electronic apparatus of claim 1, wherein the processing circuit retrieves the predetermined setting and a processing indication for processing the at least one electronic document associated to the predetermined setting from the external device via the data connection.

17. The electronic apparatus of claim 1, wherein the external device is attached with a RF-ID tag corresponding to an identification, the detector reads the identification of the RF-ID tag for determining whether to establish the data connection and whether to transmit the at least one electronic document.

18. The electronic apparatus of claim 1, wherein the detector comprises a camera for reading an identification image of the external device for identifying the external device and whether the external device is within the predetermined distance.

19. The electronic apparatus of claim 1, wherein the detector detects a relative position between the external device and the electronic apparatus, and the processing circuit performs different data operations with the external device according to different relative positions.

20. An electronic apparatus for interacting with an external device, the electronic apparatus comprising:
a transmission interface;
a detector for detecting whether the external device is within a predetermined distance from the electronic apparatus, wherein the external device is not wire connected with the electronic apparatus; and
a processing circuit, when the external device being detected within the predetermined distance by the detector, for automatically establishing a connection with the external device under a predetermined setting and for moving at least one electronic document from the external device to the electronic apparatus under the predetermined setting,
wherein the processing circuit, according to the predetermined setting, performs a predetermined operation that is adding, updating, deleting files or executing a predetermined instruction.
